(19) United States
(12) Patent Application Publication
(10) Pub. No.: US 2020/0207007 A1
(43) Pub. Date: Jul. 2, 2020

(54) METHOD OF MANUFACTURING FASTENING PORTION OF ANISOGRID COMPOSITE STRUCTURE

(71) Applicant: AGENCY FOR DEFENSE DEVELOPMENT, Daejeon (KR)

(72) Inventors: Yeon-Gwan LEE, Daejeon (KR); Jae-Young KIM, Daejeon (KR); Hong-Il KIM, Daejeon (KR); Dae-Oen LEE, Daejeon (KR)

(21) Appl. No.: 16/351,785

(22) Filed: Mar. 13, 2019

(30) Foreign Application Priority Data
Dec. 28, 2018 (KR) 10-2018-0172458

(51) Int. Cl. B29C 53/56; B29C 70/34

(52) U.S. Cl. CPC B29C 53/566; B29C 70/34

(57) ABSTRACT

A method of manufacturing a fastening portion of an anisogrid composite structure includes winding the fibers to form multiple rib parts of the fastening portion configured by winding fibers on a mold, cutting a prepreg into a shape corresponding to a shape of an opening defined by the multiple ribs, inserting the cut prepreg into the corresponding opening, covering the fastening portion with a release film, and winding a compression film on the release film to apply pressure to the fastening portion.

### CROSS REFERENCE TO RELATED APPLICATION

This application claims the benefit of Korean Patent Application No. 10-2018-0172458, filed Dec. 28, 2018, which is hereby incorporated by reference in its entirety into this application.

### BACKGROUND OF THE INVENTION

### 1. Technical Field

The present invention relates to a method of manufacturing a fastening portion of an anisogrid composite structure and, more particularly, to a method of manufacturing a fastening portion of an anisogrid composite structure, the fastening portion having no depression and step.

### 2. Description of Related Art

An anisogrid composite structure achieves weight reduction of about 20% to 50% compared with a metal structure designed to withstand the same structural load.

Because of this advantage, the anisogrid composite structure finds application in large structures such as aircraft, launch vehicles, and missiles.

A shape of the anisogrid composite structure is defined by a shape of a mold on which fiber tows are wound.

A mold is configured with an engraved pattern on which the fiber tows are wound to manufacture the anisogrid composite structure.

The anisogrid composite structure is configured with a helical rib part and a circumferential rib part by winding the fibers on the above-mentioned engraved pattern.

The helical rib part is formed along a circumference of the mold at a predetermined oblique angle about a central axis of rotation of the mold.

The circumferential rib part is formed in the circumferential orientation of the mold while being perpendicular to the central axis of rotation of the mold.

The fiber tows are repeatedly laminated along the engraved pattern of the mold to form the helical rib part and the circumferential rib part.

Therefore, there is a limit to manufacture such an anisogrid composite structure in a large size at a single time.

When manufacturing large structures such as aircraft, launch vehicles, and missiles, it is important to fasten anisogrid composite structures together.

A fastening portion required to fasten the anisogrid composite structures together plays a pivotal role in supporting the structures as a path for transmitting additional load.

Therefore, structural safety is determined depending on how such a fastening portion is manufactured and designed.

In particular, a reliable technique for manufacturing a fastening portion is required because the fastening portion in the anisogrid composite structure is the weakest part.

With respect to a technique for manufacturing the fastening portion of the anisogrid composite structure, it is most important that the technique enables changing and selecting of ply angles of the fiber tows such that the fiber tows enduring stress are oriented.

In other words, according to the technique, the fastening portion of the composite structure is required to enable of varying ply angles of layers to be laminated in order to satisfy sufficient bearing strength of holes.

In addition, the technique is required to enable flexibly adjusting laminate percentages for efficient load transfer.

Here, an optimal laminating design may vary depending on types of load (for example, tensile, compression, bending, etc.) applied to the fastening portion.

However, a conventional fastening portion of the anisogrid composite structure manufactured by performing wet filament winding has problems in that fibers to be laminated have a predetermined orientation due to characteristics of the process, and change in the ply angle is limited.

The conventional technique has a problem in that a step is formed at a joint of the fastening portion.

Such a step degrades the stability of the structure.

Therefore, it is necessary to develop a manufacturing method in which a step is not formed in the fastening portion and it is possible to achieve a desired orientation of fibers and the laminate percentages even with a simple process.

### SUMMARY OF THE INVENTION

Accordingly, the present invention has been made keeping in mind the above problems occurring in the related art, and an object of the present invention is to provide a method of manufacturing a fastening portion of an anisogrid composite structure, the fastening portion enabling varying ply angles and adjusting laminate percentages while manufacturing by performing wet filament winding such that the fastening portion has no step.

In order to accomplish the above object, the present invention provides a method of manufacturing a fastening portion of an anisogrid composite structure, which has multiple rib parts configured by winding fibers on a mold, the method including: winding the fibers to form the multiple rib parts; cutting a prepreg into a shape corresponding to a shape of an opening defined by the multiple ribs; inserting the cut prepreg into the corresponding opening; covering the fastening portion with a release film; and winding a compression film on the release film to apply pressure to the fastening portion.

The fibers constituting the cut prepreg may have orientation. In addition, multiple cut prepregs may be laminated and inserted in the opening, wherein at least one pair of the multiple laminated prepregs has fiber orientations balancing each other.

The method may further includes: removing the compression film and the release film; and winding a prepreg film having a width corresponding to a width of the fastening portion on the fastening portion before winding a rib-forming fiber.

In the winding of the prepreg film, in the case of winding the fibers such that the fiber orientation is perpendicular to a mandrel, a filament winding apparatus that has wound the rib parts may be kept used to wind the fibers continuously without breaking.

A shape of the cut prepreg may be at least one of a triangle, a quadrangle, a trapezoid, a pentagon, and a hexagon.

The compression film may have a width smaller than a width of the fastening portion for overlapping.

The fastening portion may be configured with a fastening hole.

An inner surface and an outer surface of the fastening portion adjacent to the fastening hole may be provided with a fabric material laminated inclinedly at an angle of ±45 degrees with respect to a central axis of a mandrel.

The fastening hole may be provided with a bush.

The method may further include: winding a heat-shrinkable film and curing the anisogrid composite structure.

The present invention has the following effects.

It is easy to secure desired rigidity according to an intention of a designer because it is possible to vary ply angles and laminate percentages of fibers to be laminated on a fastening portion. Thus, there is an advantage in that a strong supporting force is exerted even under load in various directions other than axial load.

In addition, the production efficiency is increased because the manufacturing process is simple.

In addition, a step of the fastening portion is removed because a composite pattern is cut and laminated whereby there is an advantage in that rigidity is ensured.

In addition, it is possible to minimize deformation of a cylinder after curing because prepregs are laminated such that orientations of the fibers are in symmetry and balanced with each other.

Furthermore, after all the lamination is completed, shrinkage may occur due to heat while curing because a heat-shrinkable film is wound and cured. Thus, excess resin can escape and voids be removed whereby defects can be minimized.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart of a method of manufacturing a fastening portion of an anisogrid composite structure according to an embodiment of the present invention;

FIG. 2 is an enlarged perspective view of the anisogrid composite structure according to the embodiment of the present invention;

FIG. 3 is a view illustrating a state where a first prepreg piece and a second prepreg piece are inserted into a fastening portion according to the embodiment of the present invention;

FIGS. 4A to 4D are exemplary views of a trapezoidal prepreg according to the embodiment of the present invention;

FIGS. 5A to 5D are exemplary views of a triangular prepreg according to the embodiment of the present invention;

FIG. 6 is an exemplary view of a hexagonal prepreg according to the embodiment of the present invention;

FIG.7 is a view illustrating that a release film and a compression film are wound according to the embodiment of the present invention;

FIG. 8 is a view illustrating that a prepreg film is wound according to the embodiment of the present invention; and

FIG. 9 is a view illustrating a state a fastening portion is depressed according to the related art; and

FIG. 10 is an enlarged cross-sectional view illustrating a step of the fastening portion according to the related art.

### DESCRIPTION OF THE PREFERRED EMBODIMENTS

Hereinbelow, an embodiment of the present invention will be described in detail with reference to the accompanying drawings.

Reference will now be made in detail to exemplary embodiments of the present invention, specific examples of which are illustrated in the accompanying drawings and described below, since the embodiments of the present invention can be variously modified in many different forms. While the present invention will be described in conjunction with the exemplary embodiments thereof, it is to be understood that the present description is not intended to limit the present invention to those exemplary embodiments. On the contrary, the present invention is intended to cover not only the exemplary embodiments, but also various alternatives, modifications, equivalents, and other embodiments that may be included within the spirit and scope of the present invention as defined by the appended claims.

The same reference numerals will be used throughout the drawings and the description to refer to the same or like elements or parts.

In addition, it will be understood that, although the terms “first”, “second”, etc. may be used herein to describe various elements, these elements should not be limited by these terms. These terms are only used to distinguish one element from another element.

For instance, a first element discussed below could be termed a second element without departing from the teachings of the present invention. Similarly, the second element could also be termed the first element. As used herein, the term “and/or” includes any and all combinations of one or more of the associated listed items.

Unless otherwise defined, all terms including technical and scientific terms used herein have the same meaning as commonly understood by one of ordinary skill in the art to which exemplary embodiments belong.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A method of manufacturing a fastening portion of an anisogrid composite structure according to an embodiment of the present invention will be described.

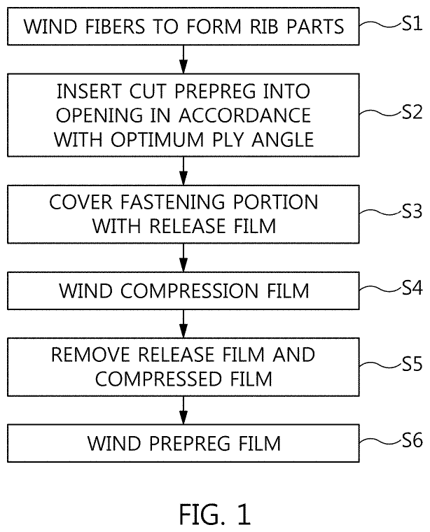

FIG. 1 is a flowchart of a method of manufacturing a fastening portion of an anisogrid composite structure according to an embodiment of the present invention.

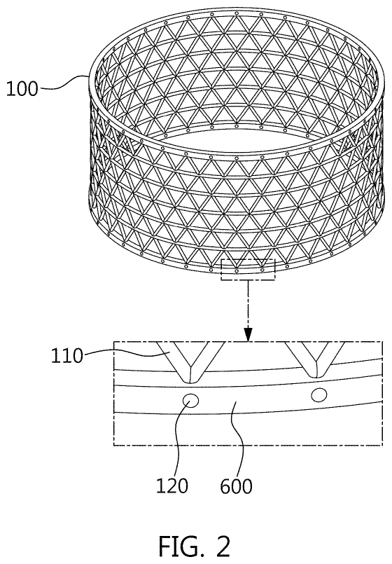

FIG. 2 is an enlarged perspective view of the anisogrid composite structure according to the embodiment of the present invention.

The anisogrid composite structure according to the embodiment of the present invention may preferably be fabricated by performing dry filament winding or wet filament winding.

A fastening portion 300 to be described later may also preferably be fabricated by performing the dry filament winding or the wet filament winding.

The entire process will be briefly described and then a detailed description will be given later.

The fastening portion 300 refers to a portion where the anisogrid structure is physically engaged with another structure, and the width thereof may be determined according to a required strength.

Winding fibers to form rib parts is performed to form a helical rib part 110 and a circumferential rib part 120 using a mandrel (not illustrated) (S1).

Each prepreg is cut into a shape corresponding to a shape of one of openings which is positioned at the fastening portion, the openings being defined by the helical rib part 110 and the circumferential rib part 120. Then, the cut prepregs are inserted into the openings (S2).

A release film is put over the fastening portion (S3).

A compression film is wound on the release film (S4).

The compressed film and the release film are removed (S5).

When the processes from S1 to S5 are regarded as one cycle, the cycle is repeated several times.

When repeating the cycle, it is important to laminate fibers such that orientations of fibers in the inserting of the prepreg into the opening (S2) and winding of a prepreg film (S6) are symmetrical and balanced with each other.

In addition, the processes from S1 to S5 are repeatedly performed, and after a desired number of layers are laminated, curing (not illustrated) is further performed.

At the curing step, a heat-shrinkable film is wound.

Then, the laminated resin and the prepregs are cured wherein the laminated resin and the prepregs are put into an oven while the mandrel is rotated and cured for a predetermined time.

In the curing step, since the heat-shrinkable film is wound and then cured, shrinkage may occur due to heat while curing, thereby excess resin can escape and voids can be removed whereby defects can be minimized.

This will be described in more detail as follows.

The rib parts are configured such that fibers are wound on a mold and constituted by the helical rib part 110 and the circumferential rib part 120.

The helical rib part 110 is connected to the circumferential rib part 120.

The circumferential rib part 120 may be formed at the end of a single anisogrid composite structure 100.

The circumferential rib part 120 is formed into a ring structure having a predetermined width and thickness.

It is preferable that the prepreg inserted in the fastening portion 300 is configured with fastening holes 600, which are holes for mechanical fastening.

The fastening holes 600 are formed in the circumferential rib part 120. It is preferable that the fastening holes 600 are formed in a region where the circumferential rib part 120 and the helical rib part 110 do not meet.

More specifically, the fastening holes 600 may be formed at regular intervals along the circumference of the circumferential rib part 120.

The fastening hole 600 is provided to improve the fastening force of which the anisogrid composite structure is connected to other structures.

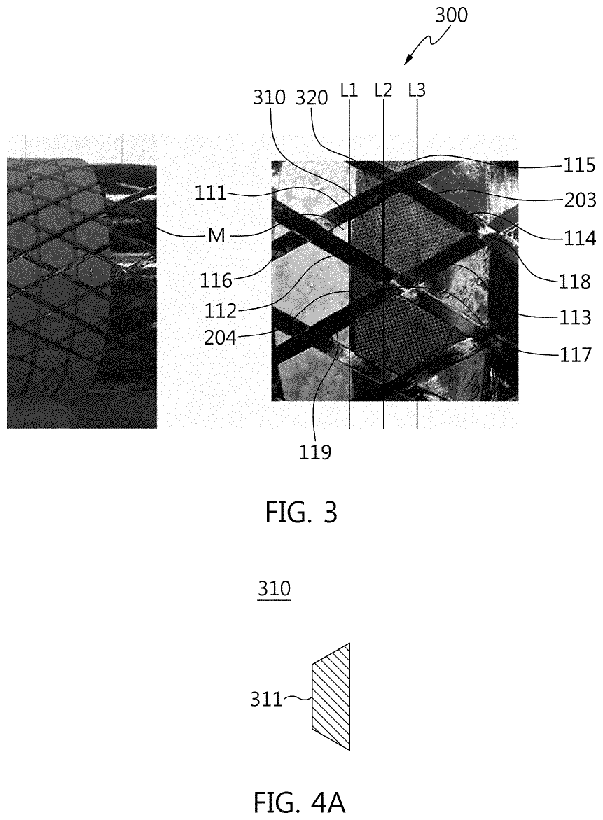

FIG. 3 is a perspective view of the fastening portion 300 according to the embodiment of the present invention.

FIG. 3 is a view illustrating a state where a first prepreg piece 203 and a second prepreg piece 204 are inserted into the fastening portion 300 according to the embodiment of the present invention;

The rib parts are configured such that the fibers are wound on the mold.

More specifically, a first helical rib part 111, a second helical rib part 112, a third helical rib part 113, and a fourth helical rib part 114 are formed such that fiber tows are laminated along an engraved portion formed on outer circumferential surface of a mold M.

The first helical rib part 111 and the third helical rib part 113 may be parallel to each other, and the second helical rib part 112 and the fourth helical rib part 114 may be parallel to each other.

The shape of the opening surrounded by the first helical rib part 111, the second helical rib part 112, the third helical rib part 113, and the fourth helical rib part 114 may define a rhombus-shaped opening.

However, since the mold M is positioned between the first helical rib part 111 and the second helical rib part 112, the mold M, the first helical rib part 111, the second helical rib part 112, the third helical rib part 113, and the fourth helical rib part 114 define a pentagonal opening.

In the cutting of the prepreg (S1), each prepreg is cut so as to correspond to shapes of the openings defined by the mold and the ribs in the fastening portion 300.

Cut prepregs 203 and 204 are inserted into the openings (S2).

More specifically, the first prepreg piece 203 may be cut into a pentagonal shape to fit in the opening of the fastening portion 300.

The triangular-shaped second prepreg piece 204 may be fitted between a fifth helical rib part 119 and the second helical rib part 112.

In other words, the prepregs may be cut in accordance with the shapes of the openings surrounded by the mold M and the multiple ribs in the fastening portion 300, and the cut prepreg pieces are inserted into the corresponding openings.

More specifically, the fastening portion 300 has a width that is a distance from a first line L1 to a point spaced from the first line L1 by a predetermined distance.

The first line L1, a second line L2, and a third line L3, which will be described below, indicate imaginary lines having an inclination of 90 degrees with respect to the central axis of the mold. The first line L1 is the right end line of the mold M.

The fastening portion may be configured to be adjustable in width in consideration of the characteristics of a structure to be connected. This is achieved by cutting at a point spaced a predetermined distance from the first line L1, such as the second line L2 or the third line L3.

Here, it is preferable that the cutting is performed at a cutting line (not illustrated) which is shifted by a predetermined distance from an actual desired cutting line (for example, the second line L2) toward the third line L3.

This is to increase the machining accuracy of the desired cutting line through the finishing of the end portion after the cutting.

Therefore, it should be understood that the shapes of the openings may also be determined by a cutting line (not illustrated), and the shapes of the prepregs inserted in the openings may be modified accordingly.

It is preferable that the cutting may be performed after the curing as described above.

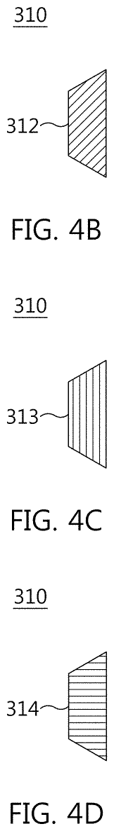

When a distance from the first line L1 to the second line L2 is defined to be the width of the fastening portion, a prepreg may be formed as a trapezoidal prepreg 310 as illustrated in FIGS. 4A to 4D.

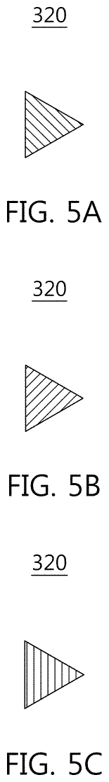

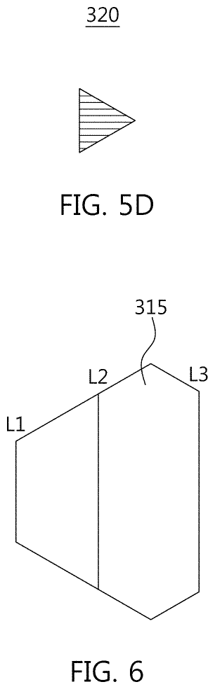

Here, a triangular prepreg 320 may be one of triangles illustrated in FIGS. 5A to 5D.

A fiber orientation of the trapezoidal prepreg 310 will be described with reference to FIGS. 4A to 4D.

The trapezoidal prepreg 310 may include a first prepreg 311, a second prepreg 312, a third prepreg 313, and a fourth prepreg 314.

A fiber orientation of the first prepreg 311 is oriented +45 degrees with respect to the central axis of the mold.

The fiber orientation of the second prepreg 312 is oriented at −45 degrees with respect to the central axis of the mold.

The fiber orientation of the third prepreg 313 is oriented at 90 degrees with respect to the central axis of the mold.

The fiber orientation of the fourth prepreg 314 is oriented at 0 degree with respect to the central axis of the mold, which means parallel to the central axis of the mold.

When the first prepreg 311 and the second prepreg 312 are laminated, the fiber orientations thereof are balanced with each other, which is advantageous for ensuring rigidity.

That is, it is preferable that the cut prepregs pieces are laminated such that the fiber orientations thereof are symmetrical to each other, and it is possible to adjust the number of prepreg pieces to be laminated and the fiber orientations thereof depending on the required strength of the fastening portion.

For example, the fiber orientations of the prepreg pieces may be sequentially laminated in the order of [±45 degrees/0 degree/90 degrees/0 degree/±45 degrees]. In addition, it is possible that a single set of this sequence, i.e., [±45 degrees/0 degree/90 degrees/0 degree/±45 degrees], is repeated several times.

Such fiber orientations are a preferred example and not limited to this, and may be provided variously such as ±15 degrees, ±20 degrees, ±30 degrees, ±35 degrees, and the like.

Accordingly, the fastening portion has symmetry and balance from the process of adjusting ply angles and a laminating order. Likewise, as illustrated in FIGS. 5A to 5D, it is possible to laminate the triangular prepreg 320 after cutting such that each triangular prepreg 320 has a fiber orientation in order to have symmetry and balance with each other.

When a distance from the first line L1 to the third line L3 is defined to be the width the fastening portion, a prepreg may be formed as a hexagonal prepreg 315 as illustrated in FIG. 6.

A first intersection 115, a second intersection 116, a third intersection 117, and a fourth intersection 118 are portions where each nonidentical pair of ribs is overlapped and laminated.

In other words, the first intersection 115 is a portion where the first helical rib part 111 and the fourth helical rib part 114 are laminated, and the second intersection 116 is a portion where the first helical rib part 111 and the second helical rib part 112 are laminated.

The third intersection 117 is a portion where the second helical rib part 112 and the third helical rib part 113 are laminated, and the fourth intersection 118 is a portion where the third helical rib part 113 and the fourth helical rib part 114 are laminated.

As described above, the overlapped and laminated portion of a pair of ribs has a height higher than non-laminated portions such that a height difference is made.

This problem may be solved by pressurizing using the compression film.

Accordingly, the method of manufacturing the fastening portion of the anisogrid composite structure according to the embodiment of the present invention may eliminate the height difference by cutting the prepregs in accordance with the shapes of the openings defined by the first helical rib part 111, the second helical rib part 112, the third helical rib part 113, and the fourth helical rib part 114 and then inserting the cut prepregs in the corresponding openings.

In other words, the prepregs may be cut into any one of a triangle, a quadrangle, a trapezoid, a pentagon, or a hexagon.

In another embodiment of the present invention, the first helical rib part 111, the second helical rib part 112, the third helical rib part 113, and the fourth helical rib part 114 may vary in winding angles with respect to the central axis of the mold.

The shape of the opening surrounded by the first helical rib part 111, the second helical rib part 112, the third helical rib part 113, and the fourth helical rib part 114 may vary.

In addition, although not illustrated, the fibers may be wound on additional ribs other than the first helical rib part 111, the second helical rib part 112, the third helical rib part 113, and the fourth helical rib part 114.

Here, a shape of each opening may be any one of a triangle, a quadrangle, a trapezoid, a pentagon, or a hexagon.

Accordingly, the prepregs may be cut into any one of a triangle, a quadrangle, a trapezoid, a pentagon, or a hexagon, and the cut prepregs are inserted into the corresponding openings.

In the putting over of the release film (S3), the fastening portion is covered with the releasing film.

More specifically, the cut first prepreg piece 203 and second prepreg piece 204 are inserted into corresponding openings of the fastening portion 300, and then the release film is wound thereon.

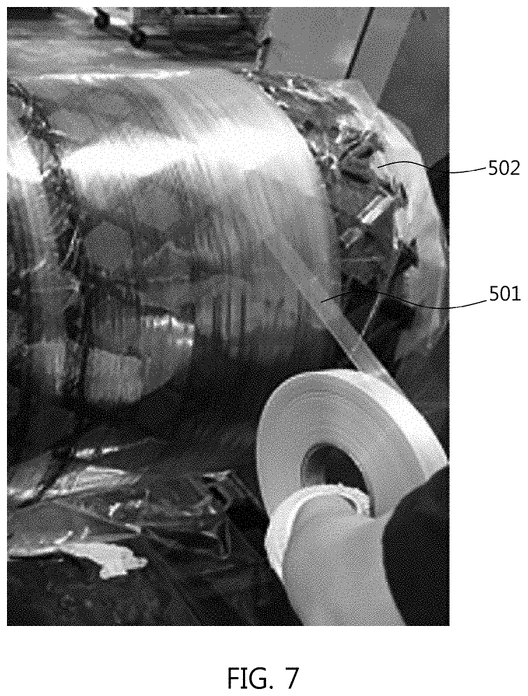

FIG. 7 is a view illustrating that a release film 502 and a compression film 501 are wound according to the embodiment of the present invention.

In the winding of the compression film (S4), the compression film 501 is wound on the release film 502 to apply pressure to the fastening portion.

The compression film 501 is cut and applies pressure to the prepregs inserted in the openings such that the prepregs spread evenly and are seated stably.

When the mold M is rotated while the mandrel (not illustrated) rotates, the compression film 501 is wound on the outer circumferential surface of the fastening portion 300 in a state in which tensile force is applied to the compression film 501.

As a result, voids in the fastening portion 300 are reduced, and the excess resin is removed.

Here, it is preferable to use the compression film 501 having a width smaller than that of the fastening portion 300 for overlapping of the compression film 501.

This is performed by moving the compression film slightly to the side for overlapping while the mandrel (not illustrated) rotates.

In the removing of the films (S5), the compression film 501 and the release film 502 are removed.

The release film 502 allows the compression film 501 to be separated from the mold M without damaging the fastening portion 300.

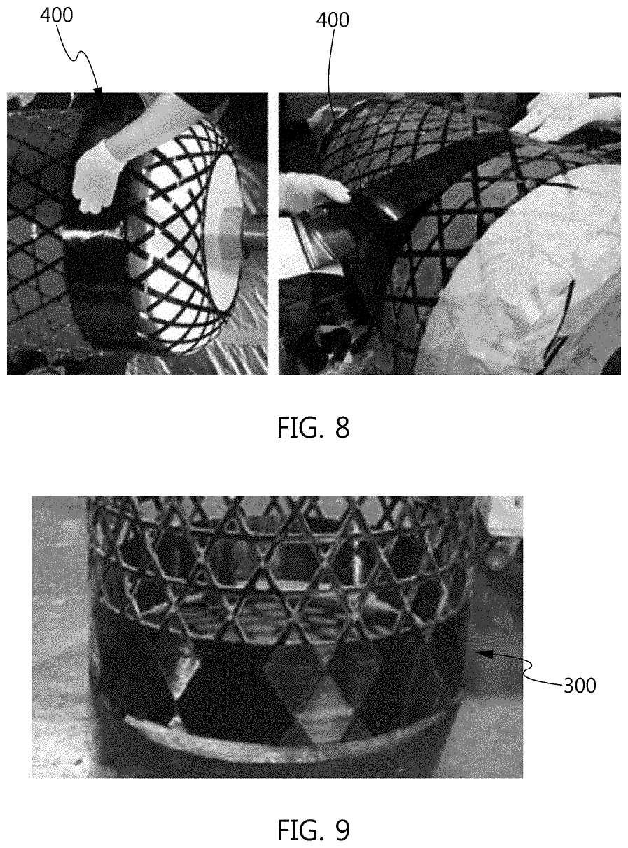

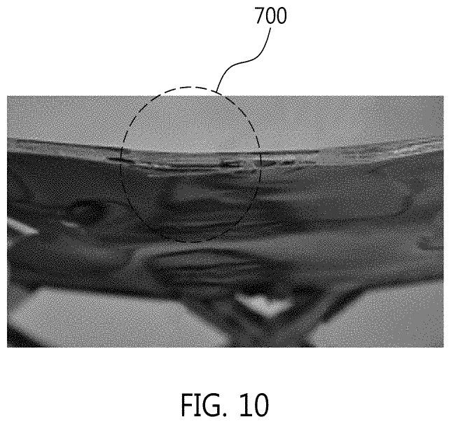

FIG. 8 is a view illustrating that a prepreg film 400 is wound according to the embodiment of the present invention.

After the removing of the films (S5), in the winding of the prepreg film (S6), the prepreg film 400 having a width corresponding to the width of the fastening portion 300 is wound on the fastening portion 300 before winding a rib-forming fiber.

Here, in the winding of the prepreg film (S6), it is preferable that a fiber orientation of the prepreg film 400 is wound at a predetermined angle with respect to the central axis of the mold.

More specifically, it is possible to laminate the prepreg film 400 in a desired orientation of the fiber to have an inclination with respect to the rotational axis of the mold.

The inclination described below indicates an angle between the fiber orientation of the cut prepreg and the central axis of rotation of the mold projected on the outer circumferential surface thereof.

In addition, “+” and “−” signs of the inclination distinguish a case of having an inclination on a first side and a case of having an inclination on a second side on the basis of on the rotational central axis projected on the outer circumferential surface of the mold.

The term “balance” used herein may be the concept of “+” and “−” signs. For example, it is a preferable balance in which a prepreg in which fiber tows have an orientation of +45 degrees with respect to a predetermined reference direction is laminated and a prepreg in which fiber tows have an orientation of −45 degrees with respect to the same predetermined reference direction is laminated thereon.

For example, the fiber of the prepreg film 400 may be wound in an orientation parallel to the circumferential rib part 120 such that the fiber is perpendicular to the rotational axis of the mold (hereinafter, referred to as 90 degree inclination).

In this case, by continuously using a filament winding apparatus that winds the rib parts, it is possible to perform the winding operation continuously without breaking the fibers.

That is, when winding the prepreg film 400 such that the fiber orientation of the prepreg film 400 has 90 degree inclination with respect to the central axis of the mandrel, it is possible to wind the fiber tows continuously without change of the apparatus in the same width as the rib parts by using the existing apparatus that winds the helical rib part.

Accordingly, the fastening portion 300 is applied pressure so that the fastening portion 300 is compressed.

As another example, the prepreg film 400 may be wound and laminated such that a designer can obtain a desired fiber orientation of various angles such as ±45 degrees, ±30 degrees, ±90 degrees, ±60 degrees, and so on.

Since it is possible to adjust the fiber orientation of the prepreg film 400 with respect to the central axis of the mandrel (not illustrated), the prepreg film 400 is provided in various ways such as ±45 degrees, ±30 degrees, ±90 degrees, and the like.

The cut prepregs maintains their positions while the entire structure is rotated in the process.

It is preferable that a fabric material is laminated on an inner surface and an outer surface of the fastening portion 300 adjacent to the fastening holes 600.

That is, a fabric material is provided at the lowermost end and the uppermost end of the fastening portion 300 formed finally, thereby preventing the fastening holes 600 from being cracked.

In other words, a fabric material may be additionally laminated on an inner circumferential surface and an outer circumferential surface of the fastening portion 300.

This is to prevent cracking in processing of the fastening holes 600.

In addition, it is preferable that the fastening holes 600 are formed in points other than a portion where the fastening portion 300 and the ribs.

This is because it is preferable that the fastening holes 600 are formed in the laminated prepreg portions to have the optimum ply angle such that it is possible to withstand the designed bearing strength between the structures.

This is because the symmetry and the balance are not excellent at the points where the fastening portion 300 and the ribs meet.

It is preferable that a bush for increasing the bearing strength of the fastening portion 300 is provided to the fastening hole 600.

What is claimed is:

1. A method of manufacturing a fastening portion of an anisogrid composite structure, which has multiple rib parts configured by winding fibers on a mold, the method comprising:
winding the fibers to form the multiple rib parts;
cutting a prepreg into a shape corresponding to a shape of an opening defined by the multiple ribs;
inserting the cut prepreg into the corresponding opening;
covering the fastening portion with a release film; and
winding a compression film on the release film to apply pressure to the fastening portion.

2. The method of claim 1, wherein the fibers constituting the cut prepreg have orientation, and
multiple cut prepregs are laminated and inserted in the opening,
wherein at least one pair of the multiple laminated prepregs has fiber orientations balancing each other.

3. The method of claim 1, further comprising:
removing the compression film and the release film; and
winding a prepreg film having a width corresponding to a width of the fastening portion on the fastening portion before winding a rib-forming fiber.

4. The method of claim 3, wherein, in the winding of the prepreg film,
in the case of winding the fibers such that the fiber orientation is perpendicular to a mandrel, a filament winding apparatus that has wound the rib parts is kept used to wind the fibers continuously without breaking.

5. The method of claim 1, wherein a shape of the cut prepreg is at least one of a triangle, a quadrangle, a trapezoid, a pentagon, and a hexagon.

6. The method of claim 1, wherein the compression film has a width smaller than a width of the fastening portion for overlapping.

7. The method of claim 1, wherein the fastening portion is configured with a fastening hole.

8. The method of claim 7, wherein an inner surface and an outer surface of the fastening portion adjacent to the fastening hole are provided with a fabric material laminated inclinedly at an angle of ±45 degrees with respect to a central axis of a mandrel.

9. The method of claim 7, wherein the fastening hole is provided with a bush.

10. The method of claim 3, further comprising:
winding a heat-shrinkable film and curing the anisogrid composite structure.
